(19) United States
(12) Patent Application Publication
(10) Pub. No.: US 2026/0270722 A1
(43) Pub. Date: Sep. 10, 2026

(54) USING A REINFORCEMENT LEARNING MODEL TO ADAPT A WIRELESS LINK

(71) Applicant: Dell Products L.P., Round Rock, TX (US)

(72) Inventor: Prashanth Murthy, Plano, TX (US)

(21) Appl. No.: 19/072,911

(22) Filed: Mar. 6, 2025

(51) Int. Cl. H04W 24/02; H04B 7/06; H04W 72/232

(52) U.S. Cl. CPC H04W 24/02; H04B 7/0632; H04W 72/232

(57) ABSTRACT

The technologies described herein are generally directed to using an incrementally updated machine learning model to select a communication parameter for a follow-up communication. For instance, a system can communicate resource information to a user equipment, with the resource information identifying resources for transmission and reception of data by the user equipment. The system may further, based on a first result determined to be applicable to the communicating of the resource information, utilize a reinforcement learning model to select a value of a communication parameter applicable to a follow-up communication of the resource information to the user equipment. The system may further, based on a second result of the follow-up communication, update the reinforcement learning model.

### BACKGROUND

Modern approaches to establishing wireless connections in radio access networks may utilize different metrics to select and adjust communication parameters. Different metrics may be used in different ways by access points and mobile devices. In some circumstances, because of performance targets, communications parameters may be selected by access points before many channel quality metrics are available.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example method may include communicating, by a computing system comprising one or more processors, resource information to a user equipment, wherein the resource information identifies resources for transmission and reception of data by the user equipment. The method may further include, based on a first result determined to be applicable to the communicating of the resource information, utilizing, by the computing system, a reinforcement learning model to select a value of a communication parameter applicable to a follow-up communication of the resource information to the user equipment. The method may further include, based on a second result of the follow-up communication, updating, by the computing system, the reinforcement learning model.

Additionally or alternatively, the resource information may include downlink control information. Additionally or alternatively, utilizing the reinforcement learning model may include, based on a context associated with the user equipment being determined to comprise a characteristic of an environment associated with the user equipment, selecting the communication parameter based on the context. Additionally or alternatively, the characteristic of the environment may include a characteristic applicable to determination of channel quality indicator by the user equipment. Additionally or alternatively, the characteristic may include at least one of, a first characteristic representative of resource elements of a physical downlink control channel, a second characteristic representative of a channel quality indicator, a third characteristic representative of a modulation and coding scheme table, a fourth characteristic representative of a bandwidth part, a fifth characteristic representative of a size of a sub-band in frequency domain, a sixth characteristic representative of a type of a demodulation reference signal, or a seventh characteristic representative of an additional position applicable to the demodulation reference signal. Additionally or alternatively, the communication parameter may include, a first parameter corresponding to an error correction protocol applicable to communication of the follow-up communication, a second parameter corresponding to an aggregation level applicable to communication of the follow-up communication, and a third parameter corresponding to a value of a link adaption parameter applicable to the follow-up communication.

Additionally or alternatively, the second result may include that the follow-up communication was unsuccessful, and wherein the updating of the reinforcement learning model is further based on the communication parameter, and the context. Additionally or alternatively, the reinforcement learning model may include a regularized logistic regression model. Additionally or alternatively, the reinforcement learning model selects the communication parameter based on a probabilistic analysis of posterior distributions of communication success probabilities applicable to communications using the communication parameter. Additionally or alternatively, the reinforcement learning model selects the communication parameter based on additional information obtained to increase accuracy of the reinforcement learning model and a threshold likelihood of success using the communication parameter for communications.

Additionally or alternatively, the first result is determined based on a hybrid automatic repeat request being received from the user equipment using a physical uplink shared channel. Additionally or alternatively, the computing system may include a wireless access point of a radio access network. Additionally or alternatively, the wireless access point may include a next-generation node B access point, and wherein the utilizing of the reinforcement learning model is performed by a medium access control scheduler of the next-generation node B access point. Additionally or alternatively, the first result may include a determination that the communicating of the resource information was unsuccessful.

An example system can operate as follows. At least one memory may store computer executable instructions, and at least one processor may be configured to process the computer executable instructions that, when executed by the at least one processor, facilitate performance of operations. The operations may include receiving, from an access node of a radio access network, a link adaption request applicable to communication between the access node and a mobile device served by the radio access network. The operations may further include, based on a parameter applicable to the communication between the access node and the mobile device, and a data structure applicable to the communication between the access node and the mobile device, selecting an error mitigation plan for retransmission of downlink control information to the mobile device. The operations may further include, based on an indication received from the access node, applicable to the retransmission of the downlink control information, modifying the data structure.

Additionally or alternatively, the data structure may include a reinforcement learning model, and wherein the parameter applicable to the communication between the access node and the mobile device may include a context applicable to the reinforcement learning model. Additionally or alternatively, the modifying of the data structure may include modifying the data structure based on the indication, the parameter, and the error mitigation plan.

Additionally or alternatively, the modifying of the data structure may include, based on the indication, the parameter, and the error mitigation plan, selecting a weight adjustment value applicable to modifying a weight of the data structure and, based on the weight adjustment value, modifying the weight of the data structure. Additionally or alternatively, the error mitigation plan may include an aggregation level of an error correction protocol applicable to retransmission of the downlink control information, and a gradient magnitude value applicable to the weight adjustment value may be based on the aggregation level. Additionally or alternatively, the gradient magnitude value was selected in accordance with an inverse relationship to the aggregation level.

An example non-transitory machine-readable medium may include executable instructions that, when executed by at least one processor, facilitate performance of operations. The operations may include identifying that a first wireless transmission, to a mobile node via a communication network, was not confirmed as received by the mobile node. The operations may further include requesting, from a radio resource manager of an access point that is part of the communication network, transmission protocol data representative of a transmission protocol applicable to communicating a second wireless transmission to the mobile node. The operations may further include, based on a determination that the second wireless transmission to the mobile node was not confirmed as received by the mobile node, communicating, to the radio resource manager, training data comprising a characteristic of the second wireless transmission.

Additionally or alternatively, the transmission protocol may include at least one of, a first protocol comprising a modulation and coding scheme applicable to the communicating of the second wireless transmission, a second protocol comprising a physical uplink shared channel power control level applicable to the communicating of the second wireless transmission. Additionally or alternatively, the characteristic of the second wireless transmission may include an interference value comprising a ratio of a signal to interference plus noise measured at the time of the second wireless transmission, and a reinforcement learning model was initialized based on the interference value.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 is an architecture diagram of an example system that can facilitate using an incrementally updated machine learning model to select a communication parameter for a follow-up communication, in accordance with one or more embodiments.

FIG. 2 is an architecture diagram of an example system that can facilitate using a reinforcement learning model to select an aggregation level for a retransmission of downlink control information, in accordance with one or more embodiments.

FIG. 3 includes a diagram that illustrates aspects of example system that can facilitate using an incrementally updated machine learning model to select a communication parameter for a follow-up communication, in accordance with one or more embodiments.

FIG. 4 includes a diagram that illustrates aspects of example system that can facilitate using an incrementally updated machine learning model to select a communication parameter for a follow-up communication, in accordance with one or more embodiments.

FIG. 5 includes pseudocode that may be used by embodiments to facilitate using an incrementally updated machine learning model to select a communication parameter for a follow-up communication, in accordance with one or more embodiments.

FIG. 6 depicts a flow diagram representing example operations of an example method that can facilitate using an incrementally updated machine learning model to select a communication parameter for a follow-up communication, in accordance with one or more embodiments.

FIG. 7 depicts an example system that can facilitate using an incrementally updated machine learning model to select a communication parameter for a follow-up communication, in accordance with one or more embodiments.

FIG. 8 depicts an example non-transitory machine-readable medium that can include executable instructions that, when executed by a processor of a system, can facilitate using an incrementally updated machine learning model to select a communication parameter for a follow-up communication, in accordance with one or more embodiments.

FIG. 9 is a schematic block diagram of a system with which the disclosed subject matter can interact; and

FIG. 10 illustrates an example block diagram of a computer operable to execute an embodiment of this disclosure.

### DETAILED DESCRIPTION

Various specific details of the disclosed embodiments are provided in the description below. One skilled in the relevant art(s) will recognize, however, that the techniques described herein can in some cases be practiced without one or more of the specific details, or with other methods, components, materials, etc. In other instances, well-known structures, materials, or operations are not shown or described in detail to avoid obscuring subject matter.

By utilizing one or more implementations as described herein, the performance, efficiency, and management of wireless access point systems may be improved, e.g., by providing approaches where establishing a connection between the wireless access point and a mobile device may be performed with less wastage of communication resources. One or more embodiments described herein are not abstract concepts; rather, they provide technical solutions to technical problems associated with concurrent reading and writing processes in computer systems, providing technical solutions to technical problems that are inextricably tied to computer systems. For example, generally speaking, one or more embodiments may increase the likelihood that a retransmission of an unsuccessful communication will be successful. Moreover, implementations described herein can provide these solutions in a manner that cannot reliably be performed by a human or even a plurality of humans, e.g., solutions may require rapid and complex processing operations that facilitate wireless networks.

Aspects of the subject disclosure will now be described more fully hereinafter with reference to the accompanying drawings in which example components, graphs and operations are shown. In the following description, for purposes of explanation, numerous specific details are set forth in order to provide a thorough understanding of the various embodiments. However, the subject disclosure may be embodied in many different forms and should not be construed as limited to the examples set forth herein.

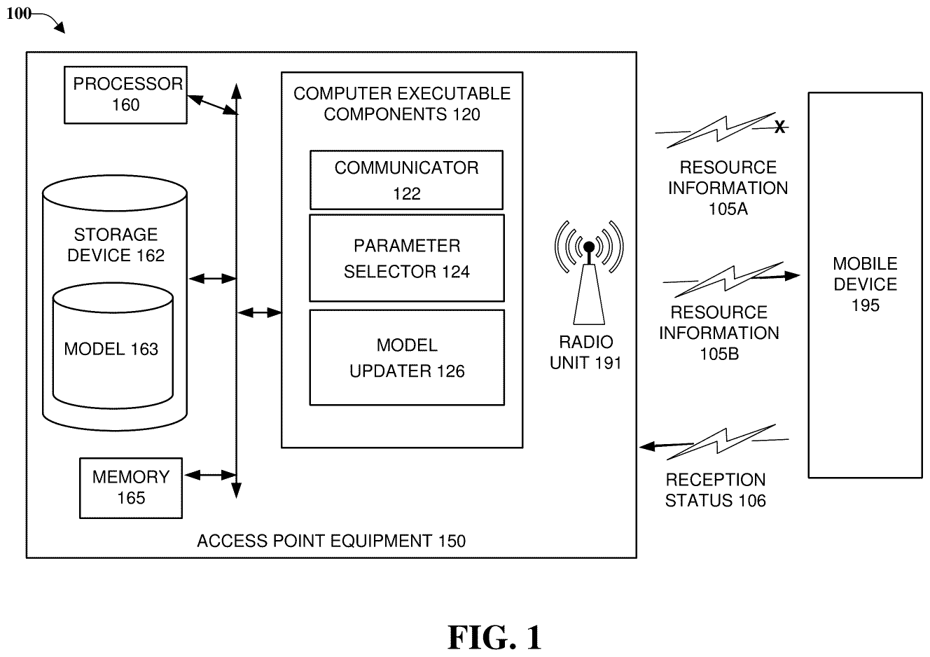

FIG. 1 is an architecture diagram of an example system 100 that can facilitate using an incrementally updated machine learning model to select a communication parameter for a follow-up communication, in accordance with one or more embodiments. For purposes of brevity, description of like elements and/or processes employed in other embodiments is omitted. As depicted, system 100 includes access point equipment 150 connected, via network 191, to mobile device 195.

As depicted, access point equipment 150 can include memory 165 that can store one or more computer and/or machine readable, writable, and/or executable components 120 and/or instructions. In embodiments, access point equipment 150 can further include processor 160. In one or more embodiments, computer executable components 120, when executed by processor 160, can facilitate performance of operations defined by the executable component(s) and/or instruction(s). Computer executable components 120 can include communicator 122, parameter selector 124, model updater 126, and other components described or suggested by different embodiments described herein, that can improve the operation of system 100. Access point equipment 150 may further include storage device 162. In an example, storage device 162 may provide nonvolatile storage of data, data structures, computer executable instructions, and so forth. In system 100, storage device 162 may store model 163, e.g., used as described below by parameter selector 124. In embodiments, access point equipment 150 can further include radio unit 191 to communicate with mobile device 195.

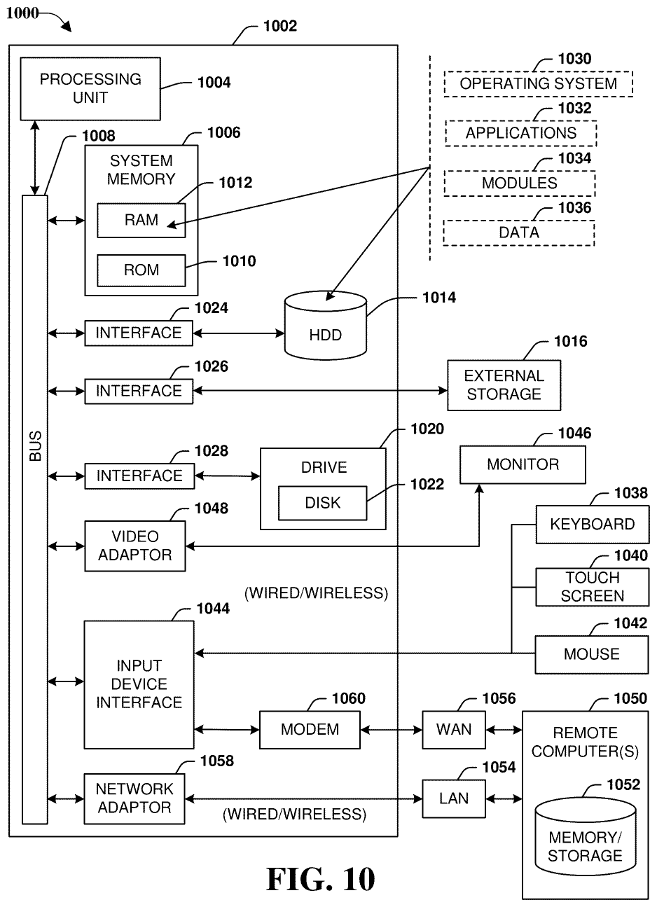

According to multiple embodiments, processor 160 can comprise one or more processors and/or electronic circuitry that can implement one or more computer and/or machine readable, writable, and/or executable components and/or instructions that can be stored on memory 165. For example, processor 160 can perform various operations that can be specified by such computer and/or machine readable, writable, and/or executable components and/or instructions including, but not limited to, logic, control, input/output (I/O), arithmetic, and/or the like. In some embodiments, processor 160 can comprise one or more components including, but not limited to, a central processing unit, a multi-core processor, a microprocessor, dual microprocessors, a microcontroller, a System on a Chip (SOC), an array processor, a vector processor, and other types of processors. Further examples of processor 160 are described below with reference to processing unit 1004 of FIG. 10. Such examples of processor 160 can be employed to implement any embodiments of the subject disclosure.

In some embodiments, memory 165 can comprise volatile memory (e.g., random access memory (RAM), static RAM (SRAM), dynamic RAM (DRAM), etc.) and/or non-volatile memory (e.g., read only memory (ROM), programmable ROM (PROM), electrically programmable ROM (EPROM), electrically erasable programmable ROM (EEPROM), etc.) that can employ one or more memory architectures. Further examples of memory 165 are described below with reference to system memory 1006 and FIG. 10. Such examples of memory 165 can be employed to implement any embodiments of the subject disclosure.

In one or more embodiments, computer executable components 120 can be used in connection with implementing one or more of the systems, devices, components, and/or computer-implemented operations shown and described in connection with FIG. 1 or other figures disclosed herein. In an example, memory 165 can store executable instructions that can facilitate generation of communicator 122, which can in some implementations can communicate resource information to a user equipment, wherein the resource information identifies resources for transmission and reception of data by the user equipment. For example, in one or more embodiments, communicator 122 may communicate resource information to a user equipment, wherein the resource information identifies resources for transmission and reception of data by the user equipment.

In an example implementation, access point equipment 150 may be an evolved node B (gNB) and a gNB scheduler may communicate resource information 105A to mobile device 195 to assign resources to mobile device 195 for transmission and reception of data, and associated feedback. In one or more embodiments, resource information corresponds to downlink control information (DCI) and identifies resources for transmission and reception of data by the user equipment. In an example, resource information 105A may be carried by the physical downlink control channel (PDCCH) in a 5G-NR deployment. Example information communicated by the carried by the resource information includes information with characteristics of the physical uplink shared channel (PUSCH) and physical downlink shared channel (PDSCH).

In another example, memory 165 can store executable instructions that can facilitate generation of parameter selector 124, which in some implementations may, based on a first result determined to be applicable to the communicating of the resource information, utilize a reinforcement learning model to select a value of a communication parameter applicable to a follow-up communication of the resource information to the user equipment. For example, in one or more embodiments, parameter selector 124 can, based on the result of communicating resource information 105A, utilize model 163 to select a value of a communication parameter applicable to communication of resource information 105B to mobile device 195.

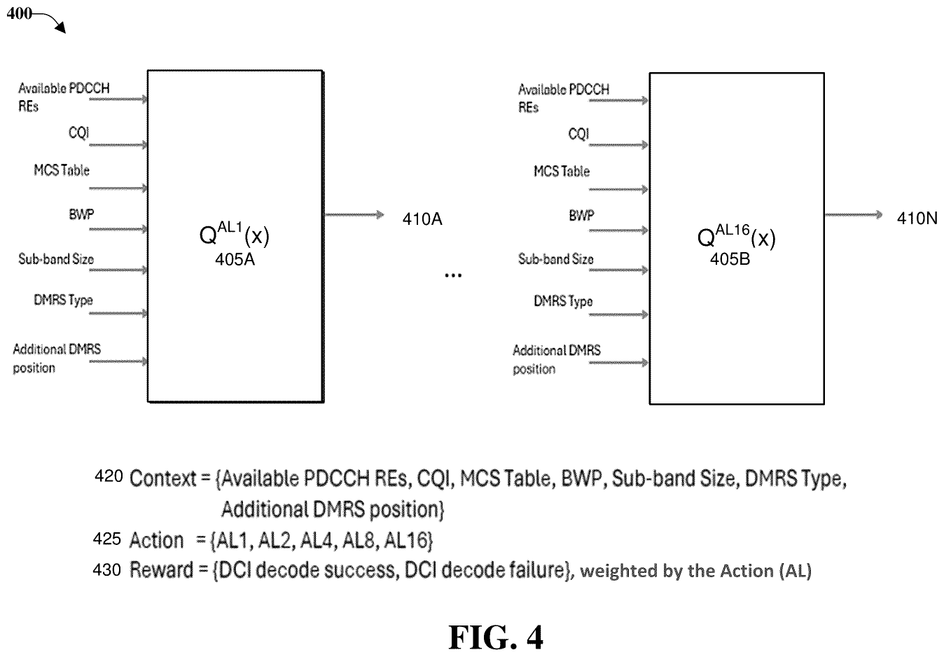

Considering this example in additional detail: In the example depicted in FIG. 4, resource information 105A was not successfully communicated to mobile device 195, e.g., the first result of the communicating of the resource information is an unsuccessful result. Based on this result, a determination may be made to use a different communication parameter to retransmit the resource information (e.g., send a follow-up communication) to mobile device 195 using the PDCCH. In one or more embodiments, a communication parameter may be selected by parameter selector 124 that may make use of aggregation levels to make the PDCCH more robust, e.g., by increasing the number of bits used for the communication by using more resources to protect the DCI by a higher level of channel coding.

In one or more embodiments, parameter selector 124 may employ reinforcement learning model (e.g., model 163) to select a PDCCH aggregation level based on characteristics of the previous attempt, and the current channel conditions. As described herein, other error-correction approaches may also be employed by using different communication parameters. In an example, the reinforcement learning model may be implemented using an immediate reinforcement learning algorithm (also termed one-step RL), e.g., a learning agent receives an immediate reward. Stated differently, using this approach, there is no notion of a long-term reward or return, because the next state is not dependent on the reward and the current state.

In an implementation, the reinforcement learning model employed by an embodiment may be characterized as a regularized logistic regression model that may select a value of the communication parameter based on a probabilistic analysis of posterior distributions of communication success probabilities applicable to communications using the communication parameter. This approach may also be termed a logistic regression model with Thompson sampling using a Beta Distribution as the prior, e.g., as a conjugate of the binomial distribution, with a reward following a Bernoulli distribution.

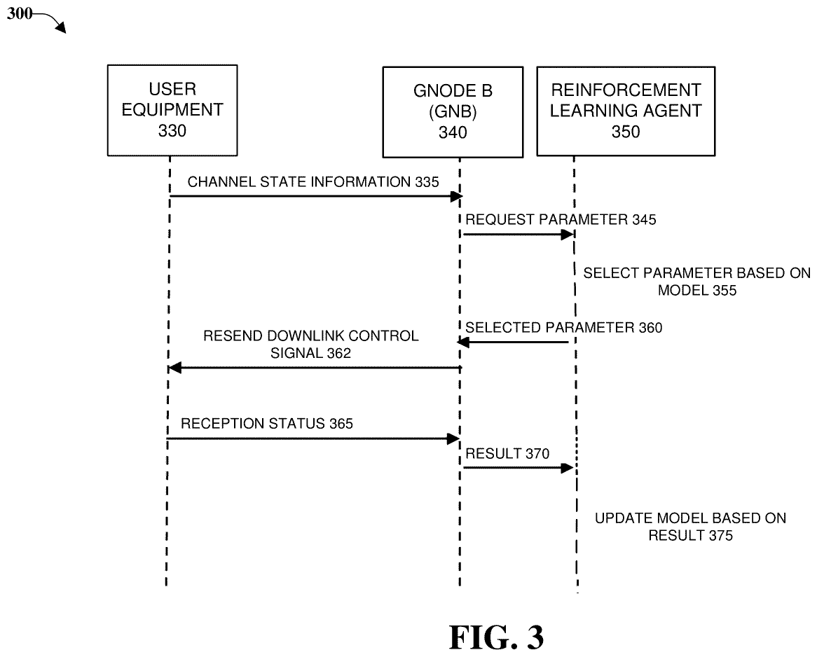

In an implementation, Thompson Sampling may be used to improve the accuracy of error correction data generated by the machine learning model. In one or more embodiments, the reinforcement learning process is not modeled as a Markov decision process as in a full reinforcement learning problem. Based at least on the reduction in complexity associated with a non-Markov decision process, one or more embodiments may be implemented on existing radio access network (RAN) infrastructure, primarily the CPU of a computing system of an access point, e.g., without any specialized AI hardware. The lack of complexity may increase the scalability of implementations and facilitate implementing reinforcement learning models that are specific to different network cells. Additional details of reinforcement learning approaches are discussed with FIGS. 3-5 below.

In another example, memory 165 can store executable instructions that can facilitate generation of model updater 126, which in some implementations may, based on a second result of the follow-up communication, update the reinforcement learning model. For example, in one or more embodiments, model updater 126 may, based on a successful transmission of resource information 105B, model 163 may be updated based on one or more of the communication parameters selected for retransmission, the previous communication parameter used for transmission of resource information 105A, and the channel state at the time of retransmission.

In one or more embodiments, using the regularized logistic approach described above with batch updates of the reinforcement learning model may reduce the amount of processing required, as compared to other approaches. One or more embodiments may be implemented so as to keep the complexity of the supervised learning model relatively low, e.g., to facilitate implementing embodiments using existing access point computing resources and to complete processing withing a target scheduling boundary. Additional details of approaches use by embodiments to update the machine learning model are discussed with FIGS. 3-5 below.

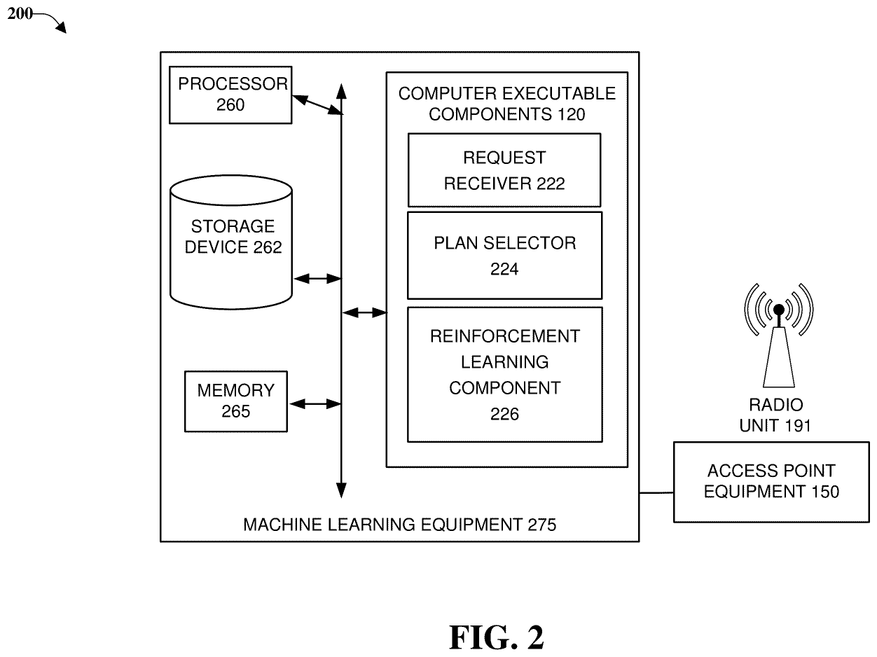

FIG. 2 is an architecture diagram of an example system 200 that can facilitate using a reinforcement learning model to select an aggregation level for a retransmission of a DCI, in accordance with one or more embodiments. For purposes of brevity, description of like elements and/or processes employed in other embodiments is omitted. As depicted, system 200 includes machine learning equipment 275 connected, via network 290, to access point equipment 150. Machine learning equipment 275 includes processor 260, memory 265, storage device 262, and computer executable components 220. In embodiments, access point equipment 150 can be coupled to include radio unit 191 to communicate with mobile devices.

In embodiments, processor 260 is similar to processor 160 and storage device 262 is similar to storage device 162, discussed above. According to multiple embodiments, memory 265 can store one or more computer and/or machine readable, writable, and/or executable components 220 and/or instructions. In one or more embodiments, computer executable components 220, when executed by processor 260, can facilitate performance of operations defined by the executable component(s) and/or instruction(s). Computer executable components 220 can include request receiver 222, plan selector 224, reinforcement learning component 226, and other components described or suggested by different embodiments described herein, e.g., that can improve the operation of system 200, in accordance with one or more embodiments.

As discussed further with FIG. 10 below, network 290 can employ various wired and wireless networking technologies. For example, embodiments described herein can be exploited in substantially any wireless communication technology, comprising, but not limited to, wireless fidelity (Wi-Fi), global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), fifth generation core (5G Core), fifth generation option 3x (5G Option 3x), high speed packet access (HSPA), Z-Wave, Zigbee and other 802.XX wireless technologies and/or legacy telecommunication technologies.

In an example implementation of machine learning equipment 275, memory 265 can store executable instructions that can facilitate generation of request receiver 222, which in some implementations, may receive, from an access node of a radio access network, a link adaption request applicable to communication between the access node and a mobile device served by the radio access network. For example, in one or more embodiments, request receiver 222 may receive, from an access node of a radio access network, a link adaption request applicable to communication between the access node and a mobile device served by the radio access network.

In an example implementation of machine learning equipment 275, memory 265 can further store executable instructions that can facilitate generation of plan selector 224, which in some implementations, may, based on a parameter applicable to the communication between the access node and the mobile device, and a data structure applicable to the communication between the access node and the mobile device, select an error mitigation plan for retransmission of downlink control information to the mobile device. For example, in one or more embodiments, plan selector 224 may, based on a parameter applicable to the communication between the access node and the mobile device, and a data structure applicable to the communication between the access node and the mobile device, select an error mitigation plan for retransmission of downlink control information to the mobile device.

In an example implementation of machine learning equipment 275, memory 265 can further store executable instructions that can facilitate generation of reinforcement learning component 226, which in some implementations, may, based on an indication received from the access node, applicable to the retransmission of the downlink control information, modify the data structure. For example, in one or more embodiments, reinforcement learning component 226 may, based on an indication received from the access node, applicable to the retransmission of the downlink control information, modify the data structure.

FIG. 3 includes a diagram that illustrates aspects of example system 300 that can facilitate using an incrementally updated machine learning model to select a communication parameter for a follow-up communication, in accordance with one or more embodiments. For purposes of brevity, description of like elements and/or processes employed in other embodiments is omitted. System 300 includes user equipment 330, gNB 340, and reinforcement learning agent 350.

To simplify the figure, the timeline of FIG. 3 begins after gNB 340 has communicated a downlink control signal (e.g., resource information, downlink channel information (DCI)) to user equipment 330, and gNB 340 has determined that the communication was not successful, e.g., by factors discussed below with the resending of the downlink control signal at 362. At 335, channel state information is provided to gNB 340 by user equipment 335. In an example, this channel state information may include a channel quality indicator (CQI). At 345, gNB 340 requests a communication parameter for retransmission of the downlink control signal, e.g., also termed a link adaption request, and/or a request for a communications plan. Alternatively, instead of gNB 340 initially determining that the communication was not successful, gNB 340 may proceed to 345, and use the link adaption request as initial communication parameters for the first communication.

As discussed further with FIG. 4 below, one or more embodiments may employ a reinforcement learning model that selects from several actions (e.g., communication parameters), based on a defined context, e.g., factors discussed below that affect the success of the retransmission transmission. To facilitate the operation of the reinforcement learning model, at 345, with the request for the communication parameter, information such as the previous parameter used for the initial transmission, and the current channel state (e.g., CQI) may be included with the request. FIG. 4 depicts an example reinforcement learning Q-function that may be employed by embodiments.

At 355, a communication parameter for a second communication may be selected by reinforcement learning agent 350 based on a machine learning model. At 360, reinforcement learning agent 350 may provide the selected communications parameter to gNB 340, and at 362, the downlink control signal may be resent by gNB 340 using the communication parameter selected. At 365, reception status of the resent downlink control signal may be communicated by user equipment 330. At 370, based on the reception status, a result of the resending of the downlink control signal with the selected parameter may be communicated from gNB 340 to reinforcement learning agent 350. As discussed further below, in one or more embodiments reinforcement learning agent 350 may use elements of this reception status to determine whether and to what extent the reinforcement learning model will be updated at 375.

For example, in an example where no feedback is received from the mobile device (e.g., no reception status 365), one or more embodiments may determine that the resending of the downlink control signal with the selected parameter was not successfully received by user equipment 330, e.g., gNB 340 may identify the communication as a discontinuous transmission (DTX). With an unsuccessful retransmission using selected parameter 360, using a reinforcement learning approach, reinforcement learning agent 350 may update the model to reflect that, given the context of the parameter request (e.g., channel state information 335), the likelihood that future communication will result in a successful transmission may be reduced.

In an example, the first result may be determined based on a hybrid automatic repeat request being received from the user equipment using the physical uplink shared channel. In an example implementation, the reinforcement learning model selects the communication parameter based on additional information obtained to increase accuracy of the reinforcement learning model and a threshold likelihood of success using the communication parameter for communications.

Alternatively, an acknowledgement (ACK) or negative acknowledgement (NACK) received from the mobile device may be interpreted as a successful DCI decode by the mobile device. In this example, with an unsuccessful retransmission using selected parameter 360, reinforcement learning agent 350 may update the model to reflect that, given channel state information 335, the likelihood that future communication will result in a successful transmission may be increased.

FIG. 4 includes a diagram that illustrates aspects of example system 400 that can facilitate using an incrementally updated machine learning model to select a communication parameter for a follow-up communication, in accordance with one or more embodiments. For purposes of brevity, description of like elements and/or processes employed in other embodiments is omitted. System 400 includes Q-functions 405A-N, values 410A-N, context 420, action 425, and reward 430. In one or more embodiments, reinforcement learning Q-function 405A predicts a likelihood of success of an action given a particular context (e.g., a channel state), and Q-function 405N predicts a likelihood of success for N subsequent decisions.

As depicted in the example of FIG. 4, context 420 includes parameters potentially affecting the CQI calculation at the mobile device, including, but not limited to, resource elements of a physical downlink control channel 410A, a CQI 410B, a modulation and coding scheme table 410C, a bandwidth part (BWP) 410D, a size of a sub-band in frequency domain 410E, a type of a demodulation reference signal 410F, and a location of an additional position applicable to the demodulation reference signal.

Actions 425 include possible aggregation levels that may be used for retransmission of the resource information, e.g., AL1, AL2, AL4, AL8, AL16. In the example, reward 430 includes a Bernoulli random variable that indicates if the decoding of the DCI by the mobile device was successful. In the example, the goal of the reinforcement learning agent is to learn a function Q(x) for each action based on the context, that returns the action value.

In an implementation, reward 430 may be weighted by a factor that depends upon the aggregation level used for the retransmission of the resource information. An example approach to selecting this weighting factor may base the weight of the reward upon a value of the aggregation level, e.g., AL1, AL2, AL4, AL8, AL16 noted above. In this example, the weighting factor may be selected to have an inverse relationship to the aggregation level, e.g., as the aggregation level increases, the weighting value decreases.

Stated differently, reinforcement learning agent 350 may be configured to change a weight of the data model (e.g., (re)train the data model) based on the reward/result 430 of the retransmission, the context of the retransmission, and the aggregation value selected for the retransmission (e.g., the error mitigation plan). In this example, a gradient magnitude of a change to a weight of the data model may be based on the aggregation level used for the retransmission, with higher aggregation levels causing a lower gradient magnitude to be applied to the result of the retransmission.

As applied, selecting the weighting factor to be inversely proportional to the aggregation level could reduce the significance of a reward to resulted from a higher aggregation level, e.g., the significance in the further training of the data model based on the reward/result. Stated differently, in certain circumstances, this weighting approach would be used in order to reduce a likelihood that the data model would be biased toward selecting a higher aggregation level. A non-limiting example set of weighting factors for aggregation levels includes: AL 1: 1.0, AL2: 0.9, AL4: 0.8, AL8: 0.7, and AL 16: 0.6.

In an implementation, the reinforcement learning agent is implemented by the media access control (MAC) scheduler or the radio resource management (RRM) component of the gNB. In some implementations the reinforcement learning agent may include a function approximator for the Q-functions, e.g., regularized logistic regression processor and a selector to explore the success of different actions.

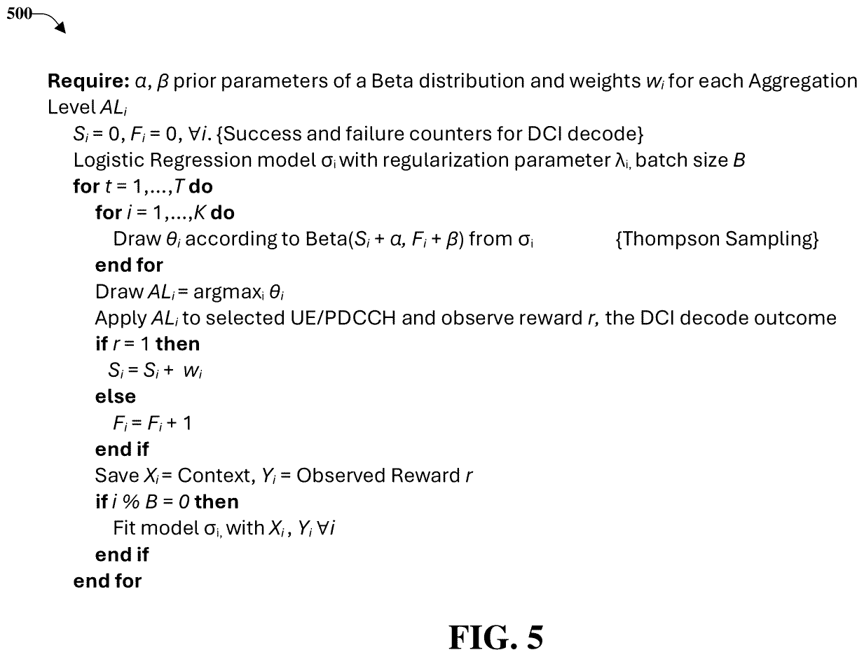

FIG. 5 includes pseudocode 500 that may be used by embodiments to facilitate using an incrementally updated machine learning model to select a communication parameter for a follow-up communication, in accordance with one or more embodiments. Repetitive description of like elements employed in one or more embodiments described herein is omitted for sake of brevity.

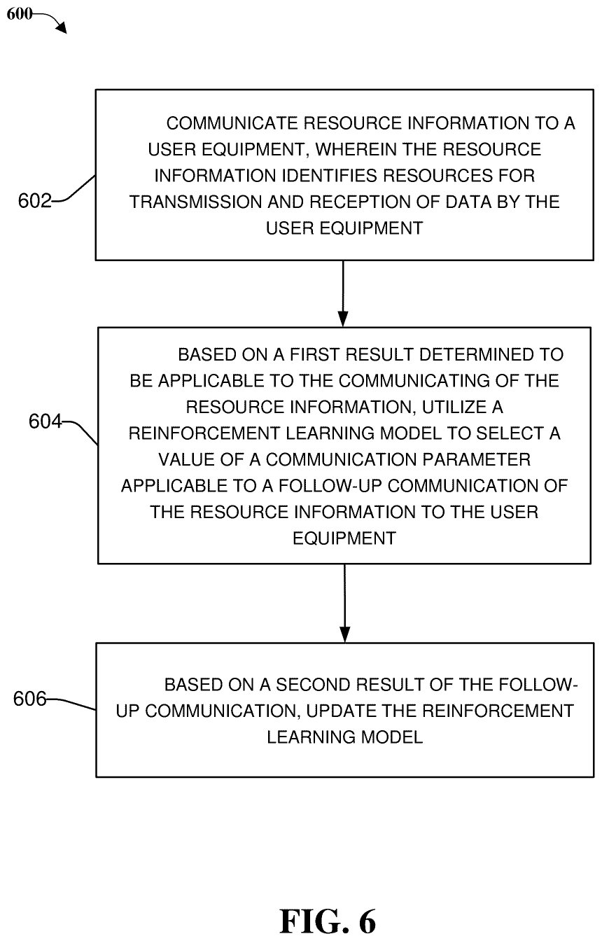

FIG. 6 depicts a flow diagram 600 representing example operations of an example method 600 that can facilitate using an incrementally updated machine learning model to select a communication parameter for a follow-up communication, in accordance with one or more embodiments. For purposes of brevity, description of like elements and/or processes employed in other embodiments is omitted.

In some examples, one or more embodiments of method 600 can be implemented by communicator 122, parameter selector 124, model updater 126, and other components that can be used to implement aspects of method 600, in accordance with one or more embodiments. FIG. 6, described below illustrates methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

At 602 of method 600, communicator 122 of access point equipment 150 can communicate resource information to a user equipment, with the resource information identifying resources for transmission and reception of data by the user equipment. At 604 of method 600, parameter selector 124 can, based on a first result determined to be applicable to the communicating of the resource information, utilize a reinforcement learning model to select a value of a communication parameter applicable to a follow-up communication of the resource information to the user equipment. At 606 of method 600, model updater 126 can, based on a second result of the follow-up communication, update the reinforcement learning model.

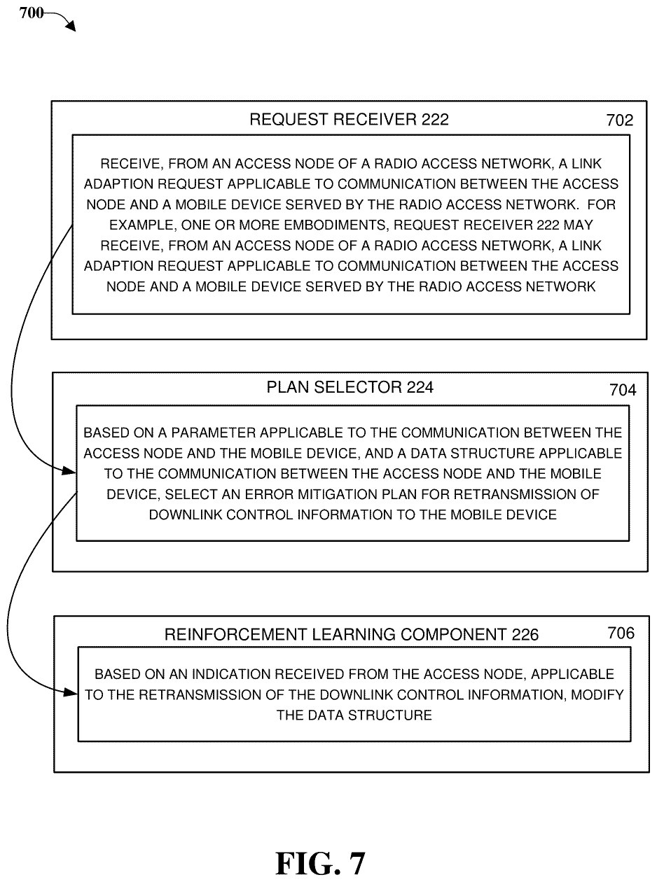

FIG. 7 depicts an example system 700 that can facilitate using an incrementally updated machine learning model to select a communication parameter for a follow-up communication, in accordance with one or more embodiments. For purposes of brevity, description of like elements and/or processes employed in other embodiments is omitted.

System 700 includes at least one memory that stores computer executable components, and at least one processor that executes the computer executable components stored in the at least one memory, with the computer executable components including request receiver 222, plan selector 224, reinforcement learning component 226, and other components that can be used to implement aspects of system 700, as described herein, in accordance with one or more embodiments.

At 702 of FIG. 7, request receiver 222 can receive, from an access node of a radio access network, a link adaption request applicable to communication between the access node and a mobile device served by the radio access network. At 704 of FIG. 7, plan selector 224 can, based on a parameter applicable to the communication between the access node and the mobile device, and a data structure applicable to the communication between the access node and the mobile device, select an error mitigation plan for retransmission of downlink control information to the mobile device. At 706 of FIG. 7, reinforcement learning component 226 can, based on an indication received from the access node, applicable to the retransmission of the downlink control information, modify the data structure.

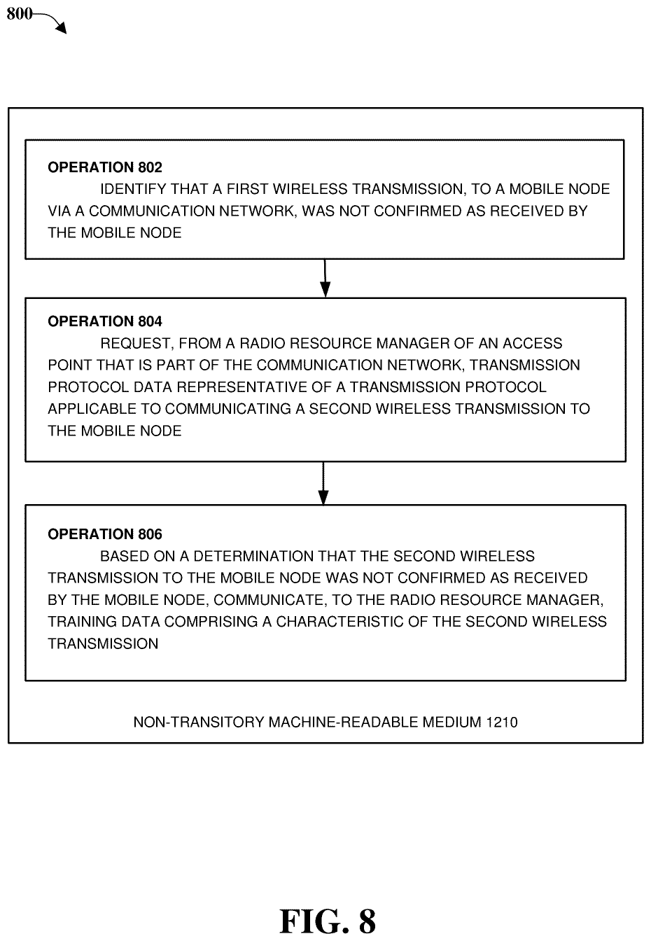

FIG. 8 depicts an example flow diagram 800 for a non-transitory machine-readable medium 810 that can include executable instructions that, when executed by a processor of a system, can facilitate using an incrementally updated machine learning model to select a communication parameter for a follow-up communication, in accordance with one or more embodiments. For purposes of brevity, description of like elements and/or processes employed in other embodiments is omitted.

As depicted, non-transitory machine-readable medium 810 includes executable instructions that, when executed by at least one processor of a machine learning device, facilitate performance of operations that include operation 802 which can identify that a first wireless transmission, to a mobile node via a communication network, was not confirmed as received by the mobile node. The operations may further include operation 804 which can request, from a radio resource manager of an access point that is part of the communication network, transmission protocol data representative of a transmission protocol applicable to communicating a second wireless transmission to the mobile node. The operations may further include operation 806 which can, based on a determination that the second wireless transmission to the mobile node was not confirmed as received by the mobile node, communicate, to the radio resource manager, training data comprising a characteristic of the second wireless transmission.

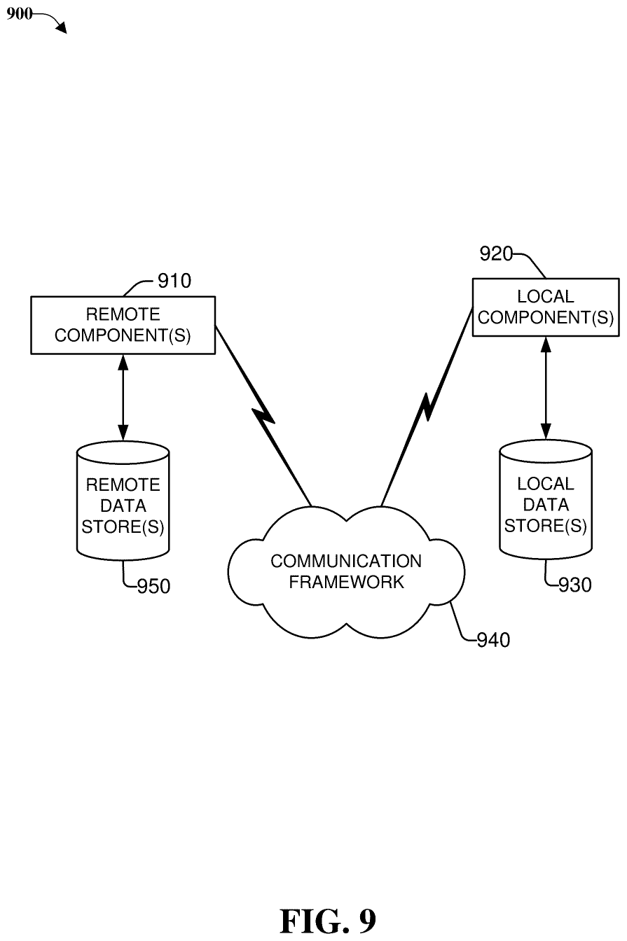

FIG. 9 is a schematic block diagram of a system 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a distributed computer system, connected to a local automatic scaling component and/or programs that use the resources of a distributed computer system, via communication framework 940. Communication framework 940 can comprise wired network devices, wireless network devices, mobile devices, wearable devices, RAN devices, gateway devices, femtocell devices, servers, etc. The system 900 also comprises one or more local component(s) 920. The local component(s) 920 can be hardware and/or software (e.g., threads, processes, computing devices).

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940.

In order to provide a context for the various aspects of the disclosed subject matter, the following discussion is intended to provide a brief, general description of a suitable environment in which the various aspects of the disclosed subject matter can be implemented. While the subject matter has been described above in the general context of computer executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

In the subject specification, terms such as “store,” “storage,” “data store,” “data storage,” “database,” and substantially any other information storage component relevant to operation and functionality of a component, refer to “memory components,” or entities embodied in a “memory” or components comprising the memory. It is noted that the memory components described herein can be either volatile memory or non-volatile memory, or can comprise both volatile and non-volatile memory, for example, by way of illustration, and not limitation, volatile memory 1020 (see below), non-volatile memory 1022 (see below), disk storage 1024 (see below), and memory storage, e.g., local data store(s) 930 and remote data store(s) 950, see below. Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random-access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in different systems, e.g., both local and remote memory storage devices.

Referring now to FIG. 10, in order to provide additional context for various embodiments described herein, FIG. 10 and the following discussion are intended to provide a brief, general description of a suitable computing environment 1000 in which the various embodiments described herein can be implemented.

While the embodiments have been described above in the general context of computer executable instructions that can run on one or more computers, those skilled in the art will recognize that the embodiments can also be implemented in combination with other program modules and/or as a combination of hardware and software. For purposes of brevity, description of like elements and/or processes employed in other embodiments is omitted.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and include any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid-state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the . NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations,” this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application program interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

Moreover, terms like “user equipment (UE),” “mobile station,” “mobile,” subscriber station,” “subscriber equipment,” “access terminal,” “terminal,” “handset,” and similar terminology, refer to a wireless device utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “network device,” “access point (AP),” “base station,” “NodeB,” “evolved Node B (eNodeB),” “home Node B (HNB),” “home access point (HAP),” “cell device,” “sector,” “cell,” and the like, are utilized interchangeably in the subject application, and refer to a wireless network component or appliance that can serve and receive data, control, voice, video, sound, gaming, or substantially any data-stream or signaling-stream to and from a set of subscriber stations or provider enabled devices. Data and signaling streams can include packetized or frame-based flows.

Additionally, the terms “core-network,” “core,” “core carrier network,” “carrier-side,” or similar terms can refer to components of a telecommunications network that typically provides some or all of aggregation, authentication, call control and switching, charging, service invocation, or gateways. Aggregation can refer to the highest level of aggregation in a service provider network wherein the next level in the hierarchy under the core nodes is the distribution networks and then the edge networks. User equipment does not normally connect directly to the core networks of a large service provider but can be routed to the core by way of a switch or radio area network. Authentication can refer to determinations regarding whether the user requesting a service from the telecom network is authorized to do so within this network or not. Call control and switching can refer to determinations related to the future course of a call stream across carrier equipment based on the call signal processing. Charging can be related to the collation and processing of charging data generated by various network nodes. Two common types of charging mechanisms found in present day networks can be prepaid charging and postpaid charging. Service invocation can occur based on some explicit action (e.g., call transfer) or implicitly (e.g., call waiting). It is to be noted that service “execution” may or may not be a core network functionality as third-party network/nodes may take part in actual service execution. A gateway can be present in the core network to access other networks. Gateway functionality can be dependent on the type of the interface with another network.

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks include Geocast technology; broadcast technologies (e.g., sub-Hz, ELF, VLF, LF, MF, HF, VHF, UHF, SHF, THz broadcasts, etc.); Ethernet; X.25; powerline-type networking (e.g., PowerLine AV Ethernet, etc.); femto-cell technology; Wi-Fi; Worldwide Interoperability for Microwave Access (WiMAX); Enhanced General Packet Radio Service (Enhanced GPRS); Third Generation Partnership Project (3GPP or 3G) Long Term Evolution (LTE); 3GPP Universal Mobile Telecommunications System (UMTS) or 3GPP UMTS; Third Generation Partnership Project 2 (3GPP2) Ultra Mobile Broadband (UMB); High Speed Packet Access (HSPA); High Speed Downlink Packet Access (HSDPA); High Speed Uplink Packet Access (HSUPA); GSM Enhanced Data Rates for GSM Evolution (EDGE) RAN or GERAN; UMTS Terrestrial Radio Access Network (UTRAN); or LTE Advanced.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such features may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive-in a manner similar to the term “comprising” as an open transition word-without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
communicating, by a computing system comprising one or more processors, resource information to a user equipment, wherein the resource information identifies resources for transmission and reception of data by the user equipment;
based on a first result determined to be applicable to the communicating of the resource information, utilizing, by the computing system, a reinforcement learning model to select a value of a communication parameter applicable to a follow-up communication of the resource information to the user equipment; and
based on a second result of the follow-up communication, updating, by the computing system, the reinforcement learning model.

2. The method of claim 1, wherein the resource information comprises downlink control information.

3. The method of claim 1, wherein utilizing the reinforcement learning model comprises:
based on a context associated with the user equipment being determined to comprise a characteristic of an environment associated with the user equipment, selecting the communication parameter based on the context.

4. The method of claim 3, wherein the characteristic of the environment comprises a characteristic applicable to determination of a channel quality indicator by the user equipment.

5. The method of claim 3, wherein the characteristic comprises at least one of:
a first characteristic representative of resource elements of a physical downlink control channel,
a second characteristic representative of a channel quality indicator,
a third characteristic representative of a modulation and coding scheme table,
a fourth characteristic representative of a bandwidth part,
a fifth characteristic representative of a size of a sub-band in frequency domain,
a sixth characteristic representative of a type of a demodulation reference signal, or a seventh characteristic representative of an additional position applicable to the demodulation reference signal.

6. The method of claim 3, wherein the communication parameter comprises:
a first parameter corresponding to an error correction protocol applicable to communication of the follow-up communication,
a second parameter corresponding to an aggregation level applicable to communication of the follow-up communication, and
a third parameter corresponding to a value of a link adaption parameter applicable to the follow-up communication.

7. The method of claim 3, wherein the second result comprises that the follow-up communication was unsuccessful, and wherein the updating of the reinforcement learning model is further based on the communication parameter, and the context.

8. The method of claim 1, wherein the reinforcement learning model comprises a regularized logistic regression model.

9. The method of claim 1, wherein the reinforcement learning model selects the communication parameter based on a probabilistic analysis of posterior distributions of communication success probabilities applicable to communications using the communication parameter.

10. The method of claim 1, wherein the reinforcement learning model selects the communication parameter based on additional information obtained to increase accuracy of the reinforcement learning model and a threshold likelihood of success using the communication parameter for communications.

11. The method of claim 1, wherein the first result is determined based on a hybrid automatic repeat request being received from the user equipment using a physical uplink shared channel.

12. The method of claim 1, wherein the computing system comprises a wireless access point of a radio access network, and wherein the wireless access point comprises a next-generation node B access point, and wherein the utilizing of the reinforcement learning model is performed by a medium access control scheduler of the next-generation node B access point.

13. A computing system, comprising:
at least one memory that stores computing executable instructions; and
at least one processor configured to process the computing executable instructions that, when executed by the at least one processor, facilitate performance of operations, comprising:
receiving, from an access node of a radio access network, a link adaption request applicable to communication between the access node and a mobile device served by the radio access network,
based on a parameter applicable to the communication between the access node and the mobile device, and a data structure applicable to the communication between the access node and the mobile device, selecting an error mitigation plan for retransmission of downlink control information to the mobile device, and
based on an indication, received from the access node, applicable to the retransmission of the downlink control information, modifying the data structure.

14. The computing system of claim 13, wherein the data structure comprises a reinforcement learning model, and wherein the parameter applicable to the communication between the access node and the mobile device comprises a context applicable to the reinforcement learning model.

15. The computing system of claim 13, wherein the modifying of the data structure comprises:
based on the indication, the parameter, and the error mitigation plan, selecting a weight adjustment value applicable to modifying a weight of the data structure, and
based on the weight adjustment value, modifying the weight of the data structure.

16. The computing system of claim 15, wherein the error mitigation plan comprises an aggregation level of an error correction protocol applicable to the retransmission of the downlink control information, and wherein a gradient magnitude value applicable to the weight adjustment value is based on the aggregation level.

17. The computing system of claim 16, wherein the gradient magnitude value was selected in accordance with an inverse relationship to the aggregation level.

18. A non-transitory machine-readable medium comprising executable instructions that, when executed by at least one processor of a computer system, facilitate performance of operations, the operations comprising:
identifying that a first wireless transmission, to a mobile node via a communication network, was not confirmed as received by the mobile node;
requesting, from a radio resource manager of an access point that is part of the communication network, transmission protocol data representative of a transmission protocol applicable to communicating a second wireless transmission to the mobile node; and
based on a determination that the second wireless transmission to the mobile node was not confirmed as received by the mobile node, communicating, to the radio resource manager, training data comprising a characteristic of the second wireless transmission.

19. The non-transitory machine-readable medium of claim 18, wherein the transmission protocol comprises at least one of:
a first protocol comprising a modulation and coding scheme applicable to the communicating of the second wireless transmission, and
a second protocol comprising a physical uplink shared channel power control level applicable to the communicating of the second wireless transmission.

20. The non-transitory machine-readable medium of claim 18, wherein the characteristic of the second wireless transmission comprises an interference value comprising a ratio of a signal to interference plus noise measured at the time of the second wireless transmission, and wherein a reinforcement learning model was initialized based on the interference value.
